(19) United States
(12) Patent Application Publication
(10) Pub. No.: US 2003/0192196 A1
(43) Pub. Date: Oct. 16, 2003

(54) Compact ultraviolet dryer for UV liquid applied on coupling region of guide ring of fishing rod

(76) Inventor: Kun Taek Bae, Incheon-shi (KR)

Correspondence Address: STAAS & HALSEY LLP, SUITE 700, 1201 NEW YORK AVENUE, N.W., WASHINGTON, DC, 20005, US

(21) Appl. No.: 10/119,859

(22) Filed: Apr. 11, 2002

(51) Int. Cl. F26B 25/06; F26B 19/00; F26B 3/34

(52) U.S. Cl. 34/275; 34/277; 34/218

(57) ABSTRACT

A compact ultraviolet dryer adapted to be conveniently carried by a user and to enable a user to easily and quickly repair a spinning rod is disclosed. The compact ultraviolet dryer includes a chamber housing, made from material which does not allow ultraviolet rays to be transmitted therethrough, and shaped into a box form, the chamber housing including side walls having retaining cuts for holding a spinning rod, a cover plate openably attached to a front face of the chamber housing, an ultraviolet lamp provided in the chamber housing to irradiate ultraviolet rays to the spinning rod received in the chamber housing, and a ballast for supplying the ultraviolet lamp with stable current.

### BACKGROUND OF THE INVENTION

1. Field of the Invention

The present invention relates to a compact ultraviolet dryer for a fishing rod, and more particularly to a compact ultraviolet dryer for drying UV liquid(paint-type adhesive which can be hardened by ultraviolet ray) applied on a coupling region of a guide ring of a fishing rod, in which a foot of the guide ring is fitted on a fishing rod and densely wound with a fine yarn to be fixed to a fishing rod.

2. Description of the Prior Art

In general, a fishing rod, in particular a spinning rod includes a plurality of guide rings. When such a guide ring is worn or damaged after to a long period of use, it is necessary to replace the worn or damaged guide ring with a fresh guide ring. A method for joining the guide ring to a spinning rod is substantially identical both in an initial stage of its manufacturing process and in a repairing stage. The guide ring is joined to a spinning rod in such a way that a foot of a guide ring fitted on a spinning rod is wound with a fine yarn and the coupling region is applied with UV liquid(paint-type adhesive which can be hardened by ultraviolet rays), followed by being dried and hardened. In this disclosure, it should be understood that the term “UV liquid” means a liquid chemical composition(a kind of paint-type adhesive) which is dried and cured by irradiation of ultraviolet rays.

In a conventional manufacturing process of a spinning rod, a large-sized ultraviolet dryer has been used, into which a plurality of spinning rods are received such that all guide rings of the spinning rods are received therein. When drying UV liquid applied to coupling regions of guide rings of spinning rods to repair the spinning rods, it is impossible to use a large-sized ultraviolet dryer. Furthermore, since a fisherman cannot freely deal with harmful ultraviolet rays when repairing a spinning rod, the spinning rod must be naturally dried for a long time after being applied with UV liquid at its coupling region of a guide ring.

### SUMMARY OF THE INVENTION

Accordingly, the present invention has been made keeping in mind the above problems occurring in the prior art, and an object of the present invention is to provide a compact ultraviolet dryer, which is adapted to quickly dry UV liquid applied to a coupling region of a guide ring of a spinning rod in a case of repairing the guide ring, as well as to be conveniently carried by a user.

In order to accomplish the above object, the present invention provides a compact ultraviolet dryer for drying UV liquid applied to a coupled region of a guide ring of a spinning rod, comprising: a chamber housing made of synthetic resin or a metal plate, which does not allow ultraviolet rays to be transmitted therethrough, and shaped into a box form, which is conveniently carried by a user, the chamber housing being provided at its both sides with side walls each having a retaining cut for holding a spinning rod; a cover plate openably attached to a front face of the chamber housing; an ultraviolet lamp provided in the chamber housing and adapted to irradiate ultraviolet rays to the coupled region of the spinning rod held in the retaining cuts of the side walls; and a ballast for supplying the ultraviolet lamp with stable current.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a compact ultraviolet dryer according to the present invention with a cover plate opened, in which a spinning rod is partially received;

FIG. 2 is a view similar to FIG. 1, in which the cover plate is closed;

FIG. 3 is a front cross-sectional view of FIG. 2; and

FIG. 4 is a side cross-sectional view of FIG. 3.

### DETAILED DESCRIPTION OF THE INVENTION

A compact ultraviolet dryer according to the present invention will be described in further detail by way of example with reference to the accompanying drawings.

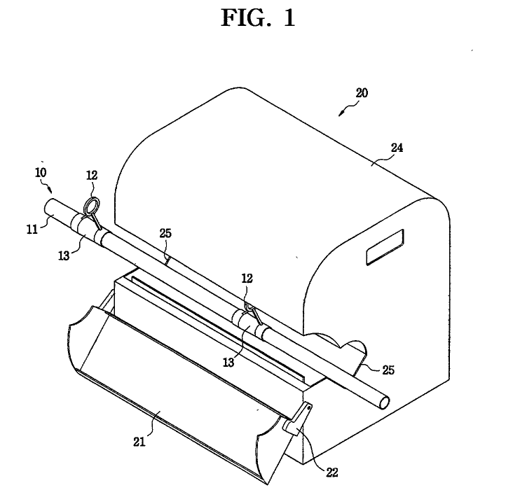

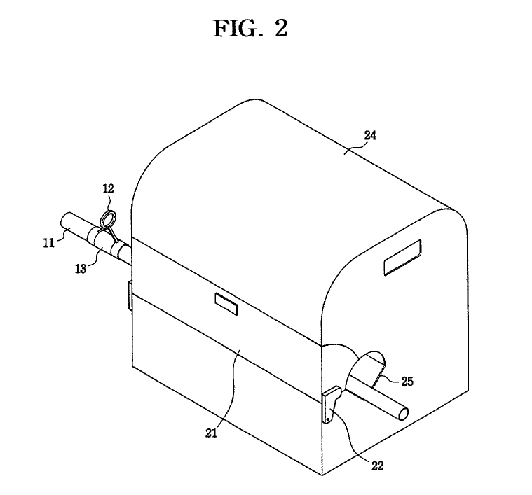

As shown in FIGS. 1 and 2, the compact ultraviolet dryer according to the present invention includes a box-shaped chamber housing 24 and a cover plate 21 which is adapted to be carried by a user and to partially receive a spinning rod therein. Both side walls of the chamber housing 24 are formed with retaining cuts 25 to hold a spinning rod to be repaired. The chamber housing 24 is made from material which does not allow ultraviolet rays to be transmitted therethrough, and fabricated in such a way that components of the chamber housing 24 are first produced by an injection molding or press molding process and then assembled together. The material for the chamber housing, which does not enable ultraviolet rays to be transmitted therethrough, includes opaque synthetic resin or a metal plate. When synthetic resin is used as the material for the chamber housing, heat resistant resin is preferably used in consideration of heat generated from an ultraviolet lamp.

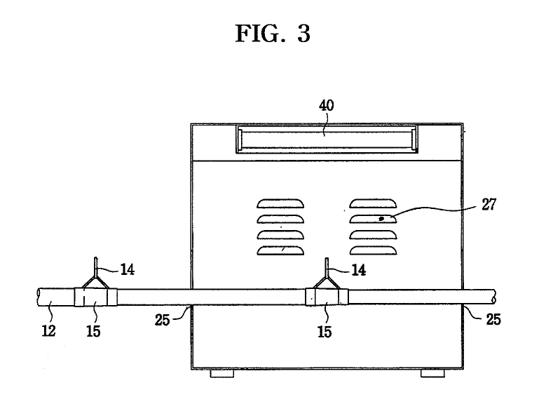

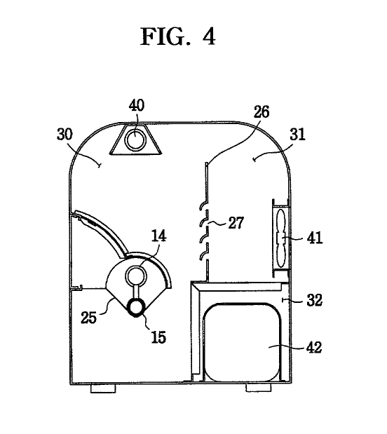

As shown in FIGS. 3 and 4, the chamber housing 24 is provided therein with an ultraviolet lamp 40 and a ballast 42 for supplying the ultraviolet lamp 40 with stable current.

As shown in FIG. 4, the chamber housing 24 is further provided therein with a blower fan 41 to cool air in the internal space of the chamber housing, which is heated by heat generated from the ultraviolet lamp 40.

The internal space of the chamber housing 24 is divided into a first or front chamber 30 and a second or rear chamber 31 by a partition wall formed with ventilation grilles 27. It is preferable that the first chamber 30 is provided at its upper portion with the ultraviolet lamp 40, and the second chamber 31 is provided at its rear portion with the blower fan so as to prevent applied UV liquid from being directly affected by the blowing air from the blower fan.

Moreover, it is preferable that the ballast 42 is provided in a third chamber 32 which is positioned under the second chamber 31, and a plurality of ventilation openings are provided between the second chamber 31 and the third chamber 32 to afford ventilation therebetween. The ventilation openings are provided for the sake of affording an attractive appearance and allowing heat generated from a power supply to be exhausted outside through the blower fan without transmission of the heat to the first chamber.

An operation of repairing a worn guide ring by the compact ultraviolet dryer according to the present invention will now be described.

After a worn or damaged guide ring is removed from a spinning rod 10, a fresh guide ring is fitted on the spinning and the guide ring is securely fastened to the spinning rod 10 by being densely wound with a fine yarn. Subsequently, a coupled region of the guide ring is applied with UV liquid. The spinning rod 10, which is applied at its coupled region with UV liquid, is received in the chamber housing 24 with the cover plate 21 opened such that the coupled region of the spinning rod to be dried is positioned at the center of the chamber housing 24. Upon turning on the ultraviolet lamp 40, the UV liquid applied to the coupled region of the spinning rod 10 is dried by ultraviolet rays irradiated from the ultraviolet lamp, in a short period of time.

As described above, the present invention provides a compact ultraviolet dryer for a spinning rod, which is adapted to be conveniently carried by a user and to enable a user to easily repair a spinning rod in a short period of time.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A compact ultraviolet dryer for drying UV liquid applied to a coupled region of a guide ring of a spinning rod, comprising:
a chamber housing made of synthetic resin or a metal plate, which does not allow ultraviolet rays to be transmitted therethrough, and shaped into a box form, which is conveniently carried by a user, the chamber housing being provided at its both sides with side walls each having a retaining cut for holding a spinning rod;
a cover plate openably attached to a front face of the chamber housing;
an ultraviolet lamp provided in the chamber housing and adapted to irradiate ultraviolet rays to the coupled region of the spinning rod held in the retaining cuts of the side walls; and
a ballast for supplying the ultraviolet lamp with stable current.

2. The compact ultraviolet dryer as set forth in claim 1, further comprising a blower fan which is provided in the chamber housing to cool air in the chamber housing heated by heat generated from the ultraviolet lamp.

3. The compact ultraviolet dryer as set forth in claim 1, in which the internal space of the chamber housing is divided into a first or front chamber and a second or rear chamber by a partition wall having ventilation grille, the first chamber being provided at its upper portion with the ultraviolet lamp, and the second chamber being provided at its rear portion with the blower fan.
